(19) United States
(12) Patent Application Publication
(10) Pub. No.: US 2019/0385549 A1
(43) Pub. Date: Dec. 19, 2019

(54) METHOD FOR INTERCEPTING LEAKAGE PIXELS OF DISPLAY PANEL AND DISPLAY PANEL THEREOF

(71) Applicant: Wuhan China Star Optoelectronics Technology Co., Ltd., Wuhan, Hubei (CN)

(72) Inventor: Yuanfu LIU, Wuhan, Hubei (CN)

(21) Appl. No.: 15/754,554

(22) PCT Filed: Jan. 17, 2018
(86) PCT No.: PCT/CN2018/073048

§ 371 Date: Feb. 22, 2018

(30) Foreign Application Priority Data
Dec. 19, 2017 (CN) 201711376813.0

(51) Int. Cl. G09G 3/36

(52) U.S. Cl. CPC G09G 3/3648

(57) ABSTRACT

A method for intercepting pixel leaked voltages of a display panel is disclosed. The method includes following steps: displaying a black frame at a first display area of the display panel and a white frame at a second display area of the display panel at the same time; intercepting a first pixel light spot, wherein the first pixel light spot is caused by the gate of a transistor leaks a gate voltage to a pixel unit coupled to the transistor while voltage leakage exists between the gate and the source of the transistor within the first display area; intercepting a second pixel light spot, wherein the second pixel light spot is caused by the gate of the transistor leaks a source voltage to the pixel unit coupled to the transistor if the voltage leakage exists between the source and the drain of the transistor within the first display area.

### RELATED APPLICATIONS

The present application is a National Phase of International Application Number PCT/CN2018/073048, filed Jan. 17, 2018, and claims the priority of China Application No. 201711376813.0, filed Dec. 19, 2017.

### FIELD OF THE DISCLOSURE

The disclosure relates to a display technical field, and more particularly to a method for intercepting leakage pixels of a display panel and the display panel thereof.

### BACKGROUND

For display panel field, a liquid crystal panel (LCD) panel is the mainstream and now widely used electronic products every day. With the development of technology, the quality of the LCD panel becomes more stringent. However, those reliability test often should take a long time, thus the development time of the LCD panel will be extended.

In the process of the LCD panel, a part of the thin film transistors (TFT) of the array substrate may have slight leakage between the gate and the source or slight leakage between the source and the drain during manufacturing. Under normal condition, a switch of the TFT will be not affected, which will not affect the LCD panel. However, in the process of reliability limit testing, it may cause quality problems and then receive complaints from users, and furthermore result in adverse effects.

### SUMMARY

For solving above problem, the purpose of this disclosure is providing a method for intercepting leakage pixels of a display panel and the display panel thereof.

In one aspect, this disclosure provides a method for intercepting leakage pixels of a display panel. The method includes following steps: displaying a black frame at a first display area of the display panel and a white frame at a second display area of the display panel at the same time; intercepting a first pixel light spot, wherein the first pixel light spot is caused by the gate of a transistor leaks a gate voltage to a pixel unit coupled to the transistor while voltage leakage exists between the gate and the source of the transistor within the first display area; intercepting a second pixel light spot, wherein the second pixel light spot is caused by the gate of the transistor leaks a source voltage to the pixel unit coupled to the transistor if the voltage leakage exists between the source and the drain of the transistor within the first display area.

In addition, the first display area comprises an upper part display area displayed on the display panel and the second display area comprises a lower part display area displayed on the display panel; or the first display area comprises a lower part display area displayed on the display panel and the second display area comprises an upper part display area displayed on the display panel.

In addition, the voltage applied on the gate of the transistor within the first display area is −7V, the voltage applied on the source of the transistor within the first display area is 5V, 0V, or −5V.

In addition, the voltage applied on the gate of the transistor within the second display area is 9V or −7V, the voltage applied on the source of the transistor within the second display area is 5V, 0V, or −5V.

In another aspect, this disclosure further provides a display panel. The display panel includes a first display area and a second display area. The first display area and the second display area include a plurality of pixels arranged in array and the pixel includes a transistor and a pixel unit coupled with the transistor. While intercepting pixel leaked voltages of the display panel, a black frame is displayed at a first display area of the display panel and a white frame is displayed at a second display area of the display panel. A first pixel light spot is intercepted, wherein the first pixel light spot is caused by the gate of the transistor leaks a gate voltage to a pixel unit coupled to the transistor while voltage leakage exists between the gate and the source of the transistor within the first display area. A second pixel light spot is intercepted, wherein the second pixel light spot is caused by the gate of the transistor leaks a source voltage to the pixel unit coupled to the transistor if the voltage leakage exists between the source and the drain of the transistor within the first display area.

In addition, the voltage applied on the gate of the transistor within the first display area is −7V, the voltage applied on the source of the transistor within the first display area is 5V, 0V, or −5V.

In addition, the voltage applied on the gate of the transistor within the second display area is 9V or −7V, the voltage applied on the source of the transistor within the second display area is 5V, 0V, or −5V.

This disclosure can detect slight defective of the display panel, and effectively intercept the defective thereof timely in process, so as to avoid that causes quality problems and then receives complaints from users.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic of a display panel according to an embodiment of the disclosure;

FIG. 2 is a structural schematic of pixels of the display panel according to the embodiment of the disclosure;

FIG. 3 is a schematic of black and white frames displayed by the display panel according to the embodiment of the disclosure;

FIG. 4 is a voltage clock schematic of the embodiment of the disclosure; and

FIG. 5 is a schematic of black and white frames displayed by the display panel according to another embodiment of the disclosure.

### DETAILED DESCRIPTION OF PREFERRED EMBODIMENTS

In order to understand the above objectives, features and advantages of the present disclosure more clearly, the present disclosure is described in detail below with references to the accompanying drawings and specific embodiments.

In the drawings, the thickness of layers and regions are exaggerated for clarity. The same reference numbers indicate the same components throughout the specification and the drawings.

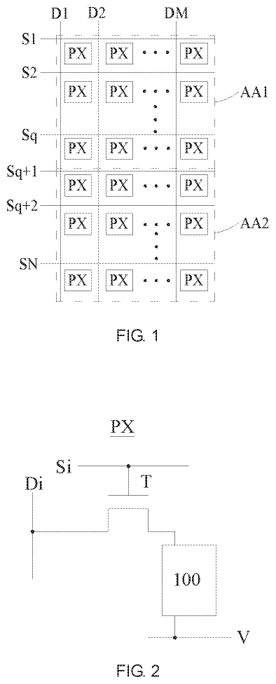

FIG. 1 is a structural schematic of a display panel according to an embodiment of the disclosure.

Reference is made to FIG. 1. Based on the embodiment of this disclosure, a display panel includes a first display area AA1 and a second display area AA2. In this embodiment, the first display area AA1 is an upper part display area displayed on the display panel and the second display area AA2 comprises a lower part display area displayed on the display panel, but it is not limited thereto.

The first display area AA1 and the second display area AA2 include a plurality of pixels PX arranged in array. It should be noted, the display panel further includes a plurality of data lines D1, D2 . . . , DM and a plurality of scanning lines S1, S2 . . . , SN. Each pixel PX is coupled to corresponded data line and scanning line, and respectively receives source voltage (or called as data voltage) from the data line and gate voltage from the scanning line.

FIG. 2 is a structural schematic of pixels of the display panel according to the embodiment of the disclosure.

Reference is made to FIG. 2. According to the embodiment of this disclosure, the pixel includes a transistor T and a pixel unit 100 coupled with the transistor T. In this embodiment, the pixel unit 100 is, for example, a liquid crystal pixel unit. The pixel unit 100 is usually consisting of a liquid crystal capacitor and a capacitor in parallel. A first end of the pixel unit 100 is coupled to the drain (or source) of the transistor T, and a second end of the pixel unit 100 is coupled to common electrode V and receives common voltage. In addition, the source (or drain) of the transistor T is coupled to the data line Di(1 [symbol] ) and receives source voltage. The gate of the transistor T is coupled to the scanning line Sj (1 [symbol] ) and receives gate voltage.

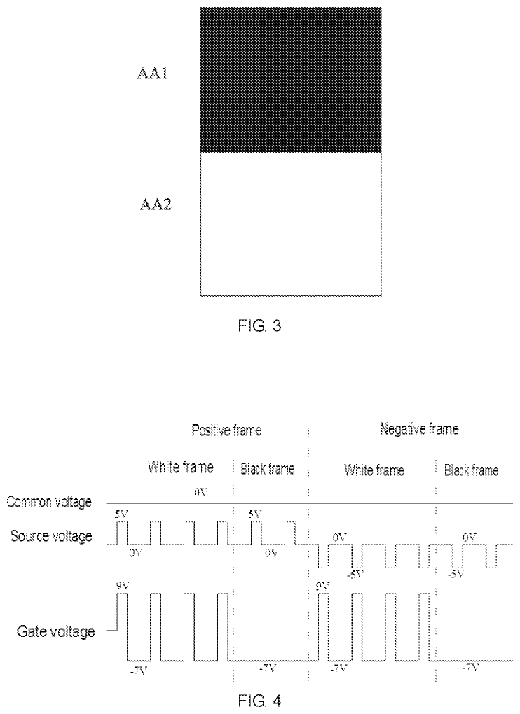

The method for intercepting leakage pixels of the display panel is described as following by FIG. 3 in conjunction with FIG. 4. FIG. 3 is a schematic of black and white frames displayed by the display panel according to the embodiment of the disclosure. FIG. 4 is a voltage clock schematic of the embodiment of the disclosure.

Reference is made to FIGS. 3 and 4. A black frame is displayed at a first display area AA1 of the display panel and a white frame is displayed at a second display area AA2 of the display panel at the same time. At this time, the half black and white frame displayed on the display can effectively intercept slight leakage between the gate and the source or between the source and the drain in respect with the pixels PX.

Specifically, whether at positive frame or negative frame, the common voltage is 0V. The positive frame means the data voltage (or called as source voltage) is positive, and the negative frame means the data voltage is negative. It is determined by liquid crystal molecules need to be driven by different voltages to achieve polarity reversal.

In the positive frame, no matter the frame is black or white, the data voltage is periodic interchanged between 5V and 0V; and in the negative frame, no matter the frame is black or white, the data voltage is periodic interchanged between −5V and 0V.

In the positive frame, for the white frame, the gate voltage is periodic interchanged between 9V and −7V; for the black frame, the gate voltage is −7V. Similarly, in the negative frame, for the white frame, the gate voltage is periodic interchanged between 9V and −7V; for the black frame, the gate voltage is −7V.

It should be illustrated that the data voltage, gate voltage and common voltage said above are respectively supplied to corresponded transistor T of the pixel PX and the pixel unit 100 within the display area.

While voltage leakage exists between the gate and the source of the transistor T within the first display area AA1, a pixel light spot is caused by the gate of the transistor T leaks a gate voltage to a pixel unit 100 coupled to the transistor T and then a pixel PX leaked voltage is intercepted since the gate voltage applied on the gate of the transistor T is constant as −7V, the source voltage applied on the source of the transistor T is periodic interchanged between 5V and 0V.

While the voltage leakage exists between the source and the drain of the transistor T within the first display area AA1, the pixel light spot is caused by the source of the transistor T leaks the source voltage (it is 5V in positive frame, and −5V in negative frame) to the pixel unit 100 coupled to the transistor T and then the pixel PX leaked voltage is intercepted.

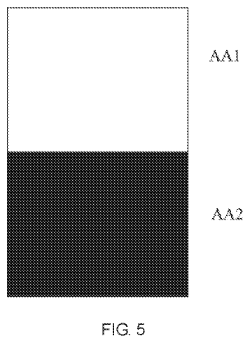

Said above, the pixel PX leaked voltage within the first display area AA1 can be intercepted. Another embodiment is intercepting the pixel PX leaked voltage within the second display area AA2. Reference is made to FIG. 5. The first display area AA1 displays the white frame, the second display area AA2 displays the black frame, and clock of each voltage is same as FIG. 4. In addition, the process of intercepting the pixel PX leaked voltage within the second display area AA2 is also same as the process of intercepting the pixel PX leaked voltage within the first display area AA1, and it is omitted thereto.

In summary, the embodiments of this disclosure can detect slight defective of the display panel, and effectively intercept the defective thereof timely in process, so as to avoid that causes quality problems and then receives complaints from users.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A method for intercepting leakage pixels of a display panel, comprising:
displaying a black frame at a first display area of the display panel and a white frame at a second display area of the display panel at the same time;
intercepting a first pixel light spot, wherein the first pixel light spot is caused by the gate of a transistor leaks a gate voltage to a pixel unit coupled to the transistor while voltage leakage exists between the gate and the source of the transistor within the first display area; or
intercepting a second pixel light spot, wherein the second pixel light spot is caused by the gate of the transistor leaks a source voltage to the pixel unit coupled to the transistor if the voltage leakage exists between the source and the drain of the transistor within the first display area.

2. The method according to claim 1, wherein the first display area comprises an upper part display area displayed on the display panel and the second display area comprises a lower part display area displayed on the display panel.

3. The method according to claim 1, wherein the first display area comprises a lower part display area displayed on the display panel and the second display area comprises an upper part display area displayed on the display panel.

4. The method according to claim 1, wherein the voltage applied on the gate of the transistor within the first display area is −7V, the voltage applied on the source of the transistor within the first display area is 5V, 0V, or −5V.

5. The method according to claim 2, wherein the voltage applied on the gate of the transistor within the first display area is −7V, the voltage applied on the source of the transistor within the first display area is 5V, 0V, or −5V.

6. The method according to claim 3, wherein the voltage applied on the gate of the transistor within the first display area is −7V, the voltage applied on the source of the transistor within the first display area is 5V, 0V, or −5V.

7. The method according to claim 4, wherein the voltage applied on the gate of the transistor within the second display area is 9V or −7V, the voltage applied on the source of the transistor within the second display area is 5V, 0V, or −5V.

8. The method according to claim 5, wherein the voltage applied on the gate of the transistor within the second display area is 9V or −7V, the voltage applied on the source of the transistor within the second display area is 5V, 0V, or −5V.

9. The method according to claim 6, wherein the voltage applied on the gate of the transistor within the second display area is 9V or −7V, the voltage applied on the source of the transistor within the second display area is 5V, 0V, or −5V.

10. A display panel, comprising a first display area and a second display area, wherein the first display area and the second display area comprise a plurality of pixels arranged in array and the pixel comprises a transistor and a pixel unit coupled with the transistor;
while intercepting pixel leaked voltages of the display panel, a black frame is displayed at a first display area of the display panel and a white frame is displayed at a second display area of the display panel; intercepting a first pixel light spot, wherein the first pixel light spot is caused by the gate of the transistor leaks a gate voltage to a pixel unit coupled to the transistor while voltage leakage exists between the gate and the source of the transistor within the first display area; or intercepting a second pixel light spot, wherein the second pixel light spot is caused by the gate of the transistor leaks a source voltage to the pixel unit coupled to the transistor if the voltage leakage exists between the source and the drain of the transistor within the first display area.

11. The display panel according to claim 10, wherein the first display area comprises an upper part display area displayed on the display panel and the second display area comprises a lower part display area displayed on the display panel.

12. The display panel according to claim 10, wherein the first display area comprises a lower part display area displayed on the display panel and the second display area comprises an upper part display area displayed on the display panel.

13. The display panel according to claim 10, wherein the voltage applied on the gate of the transistor within the first display area is −7V, the voltage applied on the source of the transistor within the first display area is 5V, 0V, or −5V.

14. The display panel according to claim 11, wherein the voltage applied on the gate of the transistor within the first display area is −7V, the voltage applied on the source of the transistor within the first display area is 5V, 0V, or −5V.

15. The display panel according to claim 12, wherein the voltage applied on the gate of the transistor within the first display area is −7V, the voltage applied on the source of the transistor within the first display area is 5V, 0V, or −5V.

16. The display panel according to claim 13, wherein the voltage applied on the gate of the transistor within the second display area is 9V or −7V, the voltage applied on the source of the transistor within the second display area is 5V, 0V, or −5V.

17. The display panel according to claim 14, wherein the voltage applied on the gate of the transistor within the second display area is 9V or −7V, the voltage applied on the source of the transistor within the second display area is 5V, 0V, or −5V.

18. The display panel according to claim 15, wherein the voltage applied on the gate of the transistor within the second display area is 9V or −7V, the voltage applied on the source of the transistor within the second display area is 5V, 0V, or −5V.
